(19) United States
(12) Patent Application Publication
(10) Pub. No.: US 2015/0074120 A1
(43) Pub. Date: Mar. 12, 2015

(54) Interactive Expert System for Recommending Chemicals and Method

(71) Applicant: Ellsworth Corporation, Germantown, WI (US)

(72) Inventor: Ephraim Ellsworth, Sai Ying Pun (HK)

(21) Appl. No.: 14/506,616

(22) Filed: Oct. 4, 2014

Related U.S. Application Data
(63) Continuation of application No. 13/681,528, filed on Nov. 20, 2012.
(60) Provisional application No. 61/716,332, filed on Oct. 19, 2012.

(51) Int. Cl. G06F 17/30; G06N 5/04

(52) U.S. Cl. CPC G06F 17/3053; G06N 5/04
USPC 707/748

(57) ABSTRACT

An interactive expert system and method is disclosed for providing ranked specific chemical product recommendations based upon general application properties information selected by a user and specific application requirements provided by a user. The interactive expert system and method assists users in the selection of chemical products based upon required, optional, or excluded chemical product characteristics and application requirements for the desired chemical product that are provided by the users. The interactive expert system and method preferably uses a ranking system that intelligently ranks the results of searching based upon the desired chemical product characteristics and the specific application requirements to order the search results. It optionally is capable of provide the user with one or more similar chemicals for any selected one of the recommended chemicals.

This patent application is a continuation-in-part of U.S. patent application Ser. No. 13/681,528, filed on Nov. 20, 2012, which is entitled “Interactive Expert System for Recommending Chemicals And Method,” which in turn claims priority of U.S. Provisional Patent Application No. 61/716,332, which was filed on Oct. 19, 2012, which is entitled “Interactive Expert System for Recommending Chemicals And Method,” both of which are assigned to the assignee of the present patent application, and both of which are hereby incorporated herein by reference in their entirety.

### BACKGROUND OF THE INVENTION

### Field of the Invention

The present invention relates generally to interactive expert systems and methods, and more particularly to an interactive expert system and method for providing ranked specific chemical product recommendations based upon general application properties information selected by a user and specific application requirements provided by a user.

It is time-consuming and difficult for engineers and purchasing agents to navigate thousands of specialty chemicals to find the right product for their specific application requirements. To the extent that websites have used filtering that would be applicable to searching for a chemical product meeting user criteria, the use of descriptive search terms is generally the only way of searching for an acceptable chemical product. Further, given a set of search terms, the chemical products located in the search produces a set of search results with the chemical products always being in the same order, since there is no intelligent agent that is ordering the results that meet minimal search criteria. Thus, if there are a large number of potential results, a user must manually review them all in order to have any assurance of finding the best possible chemical products.

It will thus be appreciated that it would be desirable to provide a system and method to assist users in the selection of chemical products from the extremely large number of chemical products that are available on the market based upon key desired chemical product characteristics and specific application requirements for the desired chemical product. It would also be desirable that such a system and method be both easy to use and that it be relatively quick to identify appropriate candidates for the product sought by a user. It would further be desirable that the system and method utilize a ranking system that intelligently ranks the results of searching based upon the desired chemical product characteristics and the specific application requirements to order the search results depending on the specific requirements that have been entered by the user.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

### SUMMARY OF THE INVENTION

The disadvantages and limitations of the background art discussed above are overcome by the present invention. With this invention, an interactive expert system and method are used to facilitate the identification of specific chemical products from the extremely large number of chemical products that are available on the market which are the best fit for key desired chemical product characteristics and/or specific application requirements that are specified by users. The interactive expert system and method of the present invention preferably allows users to utilize either or both of two different modes of entering information regarding such desired chemical product characteristics and/or specific application requirements.

In a first mode, the users can enter key properties of chemical substances that they are attempting to identify. For example, the user initially selects a property category, and then selects a property from the property category. This narrows the universe of chemical substances to those having the selected property. This can be done repeatedly, with multiple property categories and multiple properties being specified to further narrow the chemical substances having all of the selected properties.

In a second mode, the users can use a wizard that will pose questions to the user. The questions posed to the user vary according to information previously entered by the user, with a series of questions being posed and the series of responses narrowing the universe of chemical substances to those meeting the selected response. This can be done repeatedly, with the responses to multiple questions further narrowing the chemical substances meeting all of the selected responses. Both the first mode and the second mode can also be used together to enter information to located chemical substances having the desired characteristics and meeting the specific application requirements.

In an additional preferred aspect of the interactive expert system and method of the present invention, the interactive expert system uses an algorithm to organize the results of the first and/or second modes of entering information regarding such desired chemical product characteristics and/or specific application requirements in a priority from most relevant to least relevant. The ranking algorithm utilizes a number of ranking factors and a correlating number of weighting factors to rank the search results from the highest ranked to the lowest ranked. This ensures that the chemical substances best meeting the desired chemical product characteristics and/or specific application requirements are presented first.

From the results of the interactive expert system and method, the users may optionally be allowed to specify various modes of interactions. These interactions include e-mailing or mailing the search results be to the user or the user's designee, providing a quote on selected ones of the search results to the user or the user's designee, requesting that a sample of a selected one of the search results be shipped to the user or the user's designee, requesting a sales call from a representative of the operator of the interactive expert system or a representative of the chemical manufacturer, requesting expert assistance from an expert employed by the operator of the interactive expert system, and/or requesting a product demonstration from a representative of the operator of the interactive expert system or a representative of the chemical manufacturer.

In a system embodiment, a user interface module is arranged and configured to facilitate the entry of information by a user to the interactive system; a properties module operatively connected to the user interface module is arranged and configured to prompt the input, by the user, of desired properties of a chemical substance that the user is attempting to ascertain; a wizard module operatively connected to the user interface module is arranged and configured to prompt the input, by the user, of responses to questions presented by the wizard module which responses are indicative of application requirements of a chemical substance that the user is attempting to ascertain; an integration module operatively connected to the properties module and the wizard module is arranged and configured to provide a group of recommended chemical substances that are responsive to the desired properties and the responses to questions provided by the user; a ranking module operatively connected to the integration module is arranged and configured to rank the group of recommended chemical substances in a preferred order from first to last; and an output module operatively connected to the ranking module is arranged and configured to facilitate the display, to the user, of the ranked group of recommended chemical substances in the preferred order from first to last.

In another system embodiment, a user interface module is arranged and configured to facilitate the entry of information by a user to the interactive system; a properties module operatively connected to the user interface module is arranged and configured to prompt the input, by the user, of desired properties of a chemical substance that the user is attempting to ascertain; a property group database operatively connected to the properties module contains a number of different property categories; a properties database operatively connected to the properties module contains pluralities of properties associated with each of the various properties categories of the property group database, wherein the properties module is arranged and configured to allow the user to select a properties category and subsequently select a property associated with the selected properties categories; a wizard module operatively connected to the user interface module is arranged and configured to prompt the input, by the user, of responses to questions presented by the wizard module which responses are indicative of application requirements of a chemical substance that the user is attempting to ascertain; a question database operatively connected to the wizard module contains a number of different questions, wherein the wizard module is arranged and configured to allow the present questions based at least in part upon information previously provided by the user to the wizard module and/or the properties module; an integration module operatively connected to the properties module and the wizard module is arranged and configured to provide a group of recommended chemical substances that are responsive to the desired properties and the responses to questions provided by the user; a ranking module operatively connected to the integration module is arranged and configured to rank the group of recommended chemical substances in a preferred order from first to last; and an output display module operatively connected to the ranking module is arranged and configured to facilitate the display, to the user, of the ranked group of recommended chemical substances in the preferred order from first to last.

In still another system embodiment, at least one data acquisition module is configured to prompt the input, by the user, of at least one of: a. desired properties of a chemical substance that the user is attempting to ascertain; and b. a response to at least one question presented by the at least one data acquisition module which responses are indicative of application requirements of a chemical substance that the user is attempting to ascertain, wherein the at least one data acquisition module is configured to provide a group of recommended chemical substances that are responsive to the desired properties and/or the responses to questions provided by the user; a ranking module configured to rank the group of recommended chemical substances in a preferred order from first to last; and an output module configured to facilitate the display, to the user, of the ranked group of recommended chemical substances in the preferred order from first to last.

In a method embodiment, ranked specific chemical product recommendations are provided to a user by performing the steps of: facilitating the entry of information by a user with a user interface module; with a properties module operatively connected to the user interface module, prompting the input, by the user, of desired properties of a chemical substance that the user is attempting to ascertain; with a wizard module operatively connected to the user interface module, prompting the input, by the user, of responses to questions generated by a wizard module which responses are indicative of application requirements of a chemical substance that the user is attempting to ascertain; with an integration module operatively connected to the properties module and the wizard module, in response to the desired properties and the questions provided by the user, providing a group of recommended chemical substances; with a ranking module, ranking the group of recommended chemical substances in a preferred order from first to last; and with a ranking module, displaying, to the user, the ranked group of recommended chemical substances in the preferred order from first to last.

The interactive expert system and method of the present invention provides a system and method to assist users in the selection of chemical products from the extremely large number of chemical products that are available on the market based upon key desired chemical product characteristics and specific application requirements for the desired chemical product that are provided by the users. In addition to enabling engineers and purchasing agents to navigate thousands of specialty chemicals to find the right product for their specific application requirements, the interactive expert system and method of the present invention could also be used by consumers to locate adhesives having consumer applications. The consumer version of such an interactive expert system and method of the present invention may vary somewhat in that it may utilize less sophisticated questions and simplified product requirements.

The interactive expert system and method of the present invention are both easy to use and relatively quick to identify appropriate candidates for the product sought by a user. The interactive expert system and method of the present invention utilize a ranking system that intelligently ranks the results of searching based upon the desired chemical product characteristics and the specific application requirements to order the search results depending on the specific requirements that have been entered by the user. Finally, the interactive expert system and method of the present invention achieves numerous advantages without incurring any substantial relative disadvantage.

### DESCRIPTION OF THE DRAWINGS

These and other advantages of the present invention are best understood with reference to the drawings, in which:

FIG. 1 is a somewhat schematic block diagram showing an overview of an exemplary system that may be used by the interactive expert system and method of the present invention;

FIG. 2 is a somewhat schematic block diagram showing an overview of a process that may be used by the interactive expert system shown in FIG. 1 to provide ranked chemical product recommendations based upon information provided by a user;

FIGS. 3A and 3B together depict a screenshot of a web page in which general application properties information has been selected by a user using the interactive expert system shown in FIG. 1 and the process shown in FIG. 2 to select ranked chemical product recommendations;

FIGS. 4A, 4B, and 4C together depict a screenshot of a web page in which a user is responding to a series of questions proffered by an application wizard to narrow the ranked chemical product recommendations from the screenshot of FIG. 3;

FIGS. 5A, 5B, and 5C depict screenshot of web pages in which summary information, technical data information, and similar materials, respectively, are shown for a selected material;

FIG. 6 is a somewhat schematic block diagram showing added detail to the review results step, the display similar properties option step, and the select interactions mode step of the process illustrated in FIG. 2;

FIG. 7 is a somewhat schematic block diagram showing an overview of a process that may be used by the ranking module of the interactive expert system shown in FIG. 1;

FIG. 8 is a somewhat schematic block diagram showing an overview of a number of ranking factors and a correlating number of weight factors that may be used to rank by the ranking module of the interactive expert system shown in FIG. 1 and in the process shown in FIG. 7;

FIG. 9 is a somewhat schematic block diagram showing an overview of a process that may be used by the similar properties module of the interactive expert system shown in FIG. 1; and

FIG. 10 is a somewhat schematic block diagram showing an overview of a number of ranking factors and a correlating number of weight factors that may be used to select products having similar properties by the similar properties module of the interactive expert system shown in FIG. 1 and in the process shown in FIG. 9.

### DETAILED DESCRIPTION OF AN EXEMPLARY EMBODIMENT

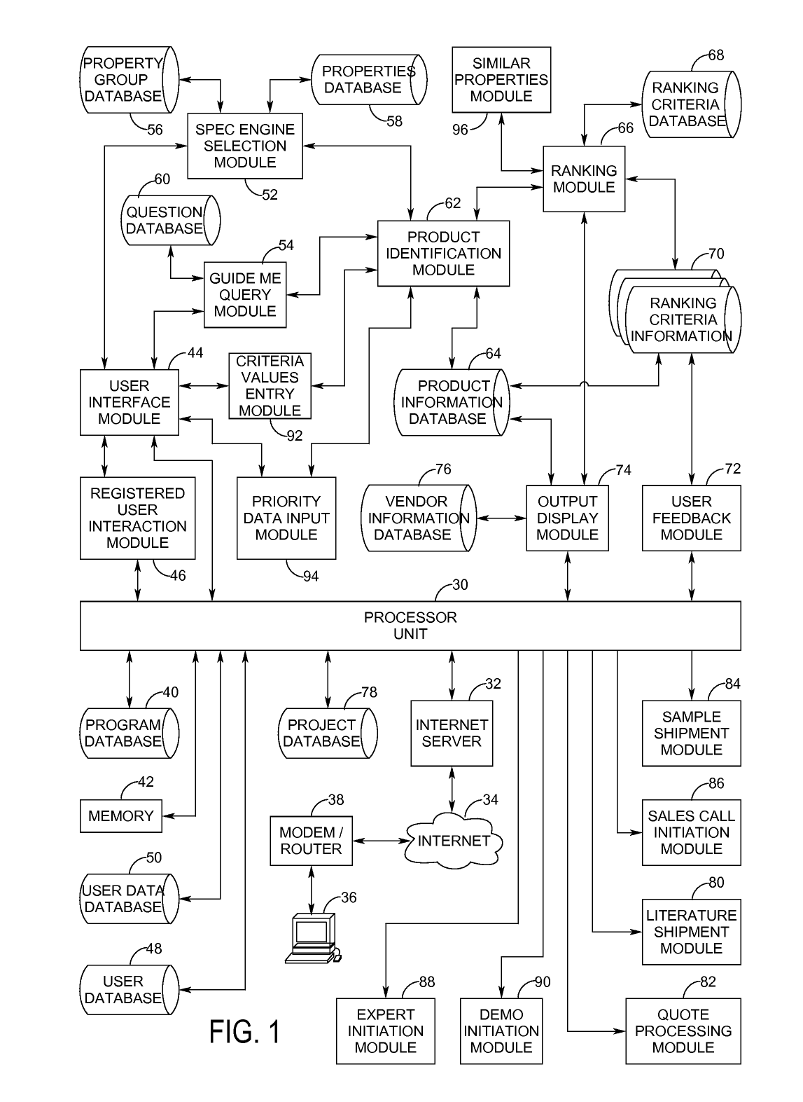

An exemplary embodiment of the interactive expert system and method of the present invention may be provided by the system illustrated in schematic block diagram fashion in FIG. 1. The interactive expert system includes a processor unit 30 to which a variety of system hardware and system modules are operatively interconnected. The processor unit 30 is connected via an Internet server 32 to the Internet 34. A user computer 36 is connected to the Internet 34 via a modem or router 38 to thereby operatively connect to the processor unit 30 of the interactive expert system and method of the present invention by logging onto a website used by the interactive expert system. It will be appreciated that the user computer 36 may be a laptop or desktop computer, a work station, a tablet, or a smartphone.

A program database 40 is operatively interconnected to the processor unit 30 to store software used by the interactive expert system and method that is not stored in firmware. A memory 42 is also operatively interconnected to the processor unit 30 to store transient information used by the interactive expert system and method.

A user interface module 44 that is operatively interconnected with the processor unit 30 is used to facilitate the entry of information by a user who has logged onto the website used by the interactive expert system. The interactive expert system and method of the present invention is configured to allow users to register on the website through the use of a registered user interaction module 46 that is operatively connected to the processor unit 30 and to the user interface module 44. Upon registration, basic user information (user logon name, user PIN, etc.) is stored in a user database 48 that is operatively connected to the processor unit 30, and more detailed user (i.e., user name, address information, e-mail address, etc.) is stored in a user data database 50 that is operatively connected to the processor unit 30.

The user interface module 44 is operatively connected to a spec engine selection module 52 and a guide me query module 54, which are key to the operational heart of the interactive expert system and method of the present invention. The spec engine selection module 52 is configured to prompt and facilitate users to enter key properties of chemical substances that they are attempting to identify through the use of the interactive expert system. The guide me query module 54 is configured to prompt and facilitate users to respond to an interactive series of questions that assist in the identification of chemical substances that they are attempting to identify through the use of the interactive expert system.

The spec engine selection module 52 is operatively connected to a property group database 56 that contains a number of different property categories and a properties database 58 that contains pluralities of properties associated with the various properties categories of the property group database 56. An exemplary table listing a plurality of properties categories that may be contained in property group database 56 and the corresponding properties that may be contained in the properties database 58 for each property is printed below as TABLE 1.

TABLE 1
PROPERTIES SEARCH GROUPS/PROPERTIES

GENERAL - MANUFACTURER [List of Manufacturers in the
Database]
GENERAL - APPLICATION TYPE (Adhesive, Sealant,
Coating, Conformal Coating, Pottant/Encapsulate, Anti-
Static, Casting/Moldmaking, Cleaner, Debonder/Remover,
Lubricant, Masking, Other, Paint, Primer, Repair &
Maintenance, Solder)
GENERAL - CHEMISTRY (Acrylic, Cationic, Cyanoacrylate,
Epoxy, Polyurethane, Silicone, Aliphatic (Hexane),
Butyl, Hot Melt, Isocyanate, Latex, Silyl Modified
Polymer (SMP), Solvent-Based, Solvent-Free, Water-
Based, Other)
GENERAL - INDUSTRY (Appliances, Construction,
Electronics, Food & Drug, Furniture/Wood Working,
Industrial, Medical, Other, Packaging,
Sign/Printing/Graphics, Sporting Equipment, Textiles,
Transportation)
GENERAL - INDUSTRY (Floor Finish, Floor Preparation,
Electronics, Industrial, Medical, Packaging,
Transportation, Appliances, Construction, Food & Drug,
Furniture/Wood-Working, Other, Sign Printing &
Graphics, Sporting Equipment, Textiles)
GENERAL - KEY SPECIFICATIONS (FDA/CFIA, Mil-Spec,
RoHS, AAMA, UL (Underwriters Laboratory)/ULC/NFPA, ABS
(American Bureau of Shipping), ANSI, ASTM, CAN/CGSB,
Class VI, CSA Intl, DOD, IPC, ISO, NSF, Other, TSCA,
TT, USDA, WEEE)
GENERAL - Acrylic
MECHANICAL - BOND STRENGTH (Structural/Load-Bearing,
General Bond Strength, Peel Strength, Shear Strength,
Tensile Strength, Cleavage Strength, Cohesive
Strength, Compressive Strength, Flexural Strength,
Green Strength, Impact Strength, Tear Strength)
PHYSICAL - COLOR (Black, Blue, Brown,
Clear/Transparent, Gray, Green, Low-Bloom, Off-White,
Orange, Pink, Purple, Red, White, Yellow, Other)
PHYSICAL - SUBSTRATE (Ceramic, Concrete, Glass, Metal,
Plastic, Rubber, Wood, Acrylic, Aluminum, Composites,
Copper, Fabric, Neoprene, Nylon, Paper, Polycarbonate,
Polyester, Polypropylene, Polyurethane, Polyvinyl
Chloride (PVC), Stainless Steel, Steel,
Stone/Construction, Other)
PHYSICAL - MATERIAL RESISTANCE (High Temperature
Resistance, Low Temperature Resistance, Chemical
Resistance, Other Resistance, Environmental
Resistance, Moisture/Humidity Resistance, Abrasion
Resistance, Impact Resistance, Relative Solvent
Resistance, UV Resistance, Vibration Resistance)
PHYSICAL - Density
PHYSICAL - Specific Volume
PHYSICAL - Specific Gravity
PHYSICAL - Glass Transition Temp (TG)
ELECTRICAL (Dissipation Factor, Volume Resistivity,
Surface Resistivity, Insulation Resistance, Dielectric
Constant, Electrical Conductivity, Dielectric
Strength)
OPTICAL (Light Refractive Index (RI))
THERMAL - (Thermal Conductivity, Coefficient of
Thermal Expansion)
HARDNESS (Shore A Hardness, Shore D Hardness,
Elasticity, Elongation, Flexibility, Modulus, Shore OO
Hardness)
PROCESSING - MATERIAL FORM (Aerosol, Liquid, Gel,
Paste, Tape, Bulk, Dot, Film, Flakes, Flux, Foam, Gas,
Grease, Other, Pad, Pellets, Powder, Stick, Strip,
Towel, Wipe, Wire)
PROCESSING - 1 Part or 2 Part
PROCESSING - APPLICATION METHOD (Brush, Dispenser,
Spray, Trowel, Contact, Dip, Flow, Other, Roll, Screen
Print, Spin-On)
PROCESSING - CURE METHOD (Heat, Moisture, 2 Part Cure,
UV/Visible Light, Air Dry, Anaerobic, Hotmelt,
Pressure Sensitive, RTV, Solvent, Other)
PROCESSING - Other (Thixotropic, Viscosity, Work/Pot
Time, Application Temperature, Fixture or Handling
Strength Time, Linear Shrinkage, Green Strength, Set
Time, Mix Ratio, Softening Point, Tack-Free Time, Cure
Temperature, Cure Time)
CONDUCTIVITY (Filler, Filler Concentration)
OTHER PROPERTIES (% Solids, Flash Point, Outgassing)

The guide me query module 54 is operatively connected to an interactive question database 60 that contains a number of different categories that are associated with various questions that may be posed to the user based upon either properties selected using the spec engine selection module 52 and/or the response to questions posed by the guide me query module 54. An exemplary table listing a plurality of question categories that may be contained in the interactive question database 60 and the corresponding properties that may be contained in the properties database 58 for each property is printed below as TABLE 2.

TABLE 2
WIZARD CATEGORIES

SEARCH BY APPLICATION TYPE (Adhesive, Instant Bonding,
Sealant, Conformal Coating, Pottant/Encapsulant,
Dielectric Isolation, Electrically Conductive, Light
Management, Thermal Management, Anti-Static,
Casting/Moldmaking, Cleaner, Coating, Gel, Lubricant,
Debonder/Remover, Masking, Paint, Primer, Repair &
Maintenance, Solder)
SEARCH BY CHEMISTRY (Acrylic, Cyanoacrylate (CA),
Epoxy, Hotmelt, Polyurethane, Silicone, Solvent-based,
Solvent-free, UV Cure, Water-based, Aliphatic
(Hexane), Butyl, Cationic, Isocyanate, Latex, Silyl-
Modified Polymer (SMP))
SEARCH BY SUBSTRATE (Ceramic, Glass, Metal, Plastic,
Rubber, Wood, Acrylic, Aluminum, Composites, Concrete,
Copper, Fabric, Neoprene, Nylon, Paper, Polycarbonate,
Polyester, Polypropylene, Polyurethane, Polyvinyl
Chloride (PVC), Steel, Stainless Steel)
SEARCH BY MANUFACTURER (3M, ACL Staticide, Armstrong,
Bondmaster, Bostik, Camie Campbell, Cytec, Dow
Corning, Dynaloy, Dymax, Eclectic Products, Emerson &
Cuming, Flamemaster, FPC Corporation, Glue Dots, The
Glue Factory, GS Polymer, Hardman, Heartland Adhesive,
HB Fuller, Henkel Loctite, Humiseal, Identco, ITW
Devcon, Lord, Microcare, Permabond, Resinlab, Resin
Designs, Resin Technology Group, Ruscoe Pliobond,
Schnee-Morehead, SCIGRIP (formerly Weld-On), Sherwin
Williams, Sika, Techspray)
SEARCH BY END-PRODUCT (Electronics, Industrial,
Medical, Transportation, Packaging, Appliances,
Automotive, Construction, Disk Drive, Food & Drug,
Furniture/Wood Working, Lighting, LED (Light-emitting
diodes), Marine, Sign, Printing and Graphics, Solar,
Sporting Equipment, Textiles)
SEARCH BY FOOD TEMPERATURE
BOND (Substrates, Cure Time, Material Exposure
Criteria, 1 or 2 Part)
SEAL (Substrates, Material Exposure Criteria, Color)
COAT (Cure Time, Material Exposure Criteria, Cure
Method, Key Specifications)
CONFORMAL COAT (Cure Time, Material Exposure Criteria,
Cure Method, Key Specifications)
POT/ENCAPSULATE (Substrates, Cure Time, Material
Exposure Criteria, 1 or 2 Part, UL Listed?)
ACCELERATE
ANTI-STATIC (Type of Anti-Static Material Required)
CASTING/MOLDMAKING
CLEAN (Substrates)
DEBOND OR REMOVE (Substrates)
LUBRICATE (Type of Lubricant Required)
MASK
MEDICAL DEVICES (Item to be Bonded, Implanted?,
Sterilization Required?)
PAINT (Substrate)
PRIME (Substrate)
REPAIR & MAINTAIN (Substrate)
SOLDER (Solder Material Required)

The selection of property groups and properties in the spec engine selection module 52 and the responses to questions in the guide me query module 54 are integrated by a product identification module 62, which is operatively connected to the spec engine selection module 52 and the guide me query module 54. The product identification module 62 is also operatively connected to a product information database 64 that contains highly detailed information indexed into a large number of fields for a large number of different chemical products representing at least in part a significant portion of the available universe of chemical products that the interactive expert system and method of the present invention is arranged and configured to be capable of recommending. The product identification module 62 thus takes the user's selection of property groups and properties in the spec engine selection module 52 and responses to questions in the guide me query module 54 and searches the product information database 64 to match chemical products that meet the criteria entered by the user.

Since it is entirely possible (and may even be highly likely) that even with the user's selection of property groups and properties in the spec engine selection module 52 and responses to questions in the guide me query module 54 there may be a large number of recommended chemicals from the product information database 64 that are identified by the product identification module 62 as meeting the user's criteria, a ranking module 66 is operatively connected to the product identification module 62 and is used by the interactive expert system and method of the present invention to select the order in which the recommended chemicals identified by the product identification module 62 will be displayed to users (and particularly which recommended chemicals will be selected in the highest positions).

The recommended chemicals in the highest positions represent a most recommended organization of the chemicals identified by the product identification module 62 as meeting the user's requirements based upon the user's selection of property groups and properties in the spec engine selection module 52 and responses to questions in the guide me query module 54. The criteria that are used by the interactive expert system and method of the present invention to arrange the ranking of recommended chemicals fitting the user's requirements as well as the relative weighting of these criteria are established by a ranking criteria database 68 that is operatively connected to the ranking module 66. These ranking criteria will be elaborated upon in conjunction with the discussion of FIG. 8 below.

Information (values) for each of the criteria for each of the chemicals identified by the product identification module 62 as meeting the user's requirements is provided by ranking criteria information databases 70, which is operatively connected to the ranking module 66. The ranking criteria information databases 70 contains some of the information used to rank the chemicals identified by the product identification module 62 as meeting the user's requirements from the product information database 64, to which the ranking criteria information databases 70 is operatively connected. In a preferred embodiment, a user feedback module 72 is also operatively connected to the processor unit 30 and the ranking criteria information databases 70 to provide user feedback information to the ranking criteria information databases 70, which can also be provided to the ranking module 66 to affect in part the ranking chemicals identified by the product identification module 62 as meeting the user's requirements.

The recommended chemicals fitting the user's requirements based upon the user's selection of property groups and properties in the spec engine selection module 52 and responses to questions in the guide me query module 54 as ranked by the ranking module 64 are then displayed to users in ranked order on the user computer 36 through the use of an output display module 74, which is operatively connected to the ranking module 66 and the processor unit 30. The output display module 74 displays information regarding the ranked recommended chemicals fitting the user's requirements which it obtains from the product information database 64, to which it is also operatively connected. The output display module 74 displays information regarding vendors of the ranked recommended chemicals, which it obtains from a vendor information database 76 to which it is also operatively connected.

Optionally, a user can save information regarding the ranked recommended chemicals fitting the user's requirements, so long as the user is a registered user. The information regarding each search based upon the user's interaction with the interactive expert system (including searches for particular chemicals) and the user's selection of property groups and properties in the spec engine selection module 52 and responses to questions in the guide me query module 54 as ranked by the ranking module 64 may be saved as a project in a project database 78 that is operatively connected to the processor unit 30.

In a preferred embodiment, information regarding selected ones of the ranked recommended chemicals identified in a search can be either printed by a user on a printer (not shown) connected to the user computer 36, or e-mailed or mailed to the user or another person identified by the user through the use of a literature shipment module 80 that is operatively connected to the processor unit 30. In a preferred embodiment, the user can also request a quote on selected ones of the ranked recommended chemicals identified in the search, with the quote being either printed by the user or e-mailed or mailed through the use of a quote processing module 82 that is operatively connected to the processor unit 30.

In an optional embodiment, a sample of a selected one of the ranked recommended chemicals identified in the search can be shipped to the user or another person identified by the user through the use of a sample shipment module 84 that is operatively connected to the processor unit 30. In another optional embodiment, a sales call from a representative of the company operating the interactive expert system and method or a representative of the manufacturer can be arranged through the use of a sales call initiation module 86 that is operatively connected to the processor unit 30.

In yet another optional embodiment, information regarding a search may be forwarded to an expert for further assistance in selection of a product through the use of an expert initiation module 88 that is operatively connected to the processor unit 30. An example of the use of such an expert in research and technical consulting in the field of consumer and industrial glue and adhesive applications is the “Ask The Glue Doctor” program operated by the assignee of the present patent application. In still another optional embodiment, a demonstration of a selected one of the ranked recommended chemicals identified in the search can be arranged for the user through the use of a demo initiation module 90 that is operatively connected to the processor unit 30.

There are three additional optional modules that may be used to expand the capabilities of the interactive expert system and method of the present invention. First, in a criteria values entry module 92, the opportunity is afforded the user of the interactive expert system and method to provide values or ranges of values in the various properties of the material that the user is searching for. For example, ranges of times or temperatures may be entered, with specific numbers for the values or ranges of values being established in the interactive expert system and method by the user.

Second, in a priority data input module 94, the opportunity is afforded the user of the interactive expert system and method of the present invention to make a specified property either required, optional, or excluded. Without the priority data input module 94, a specified property would always be required. This option enables a user to indicate that a specified property is desirable but not mandatory (optional), or that a specified property must be avoided.

Third, in a similar properties module 96, the interactive expert system and method of the present invention is given the additional capability of providing alternatives to a selected material. By selecting this option, the interactive expert system and method will search for and identify one or more alternative materials having the same properties as those of the selected material. In this feature, the alternative materials are selected using criteria specified by the interactive expert system rather than by the user.

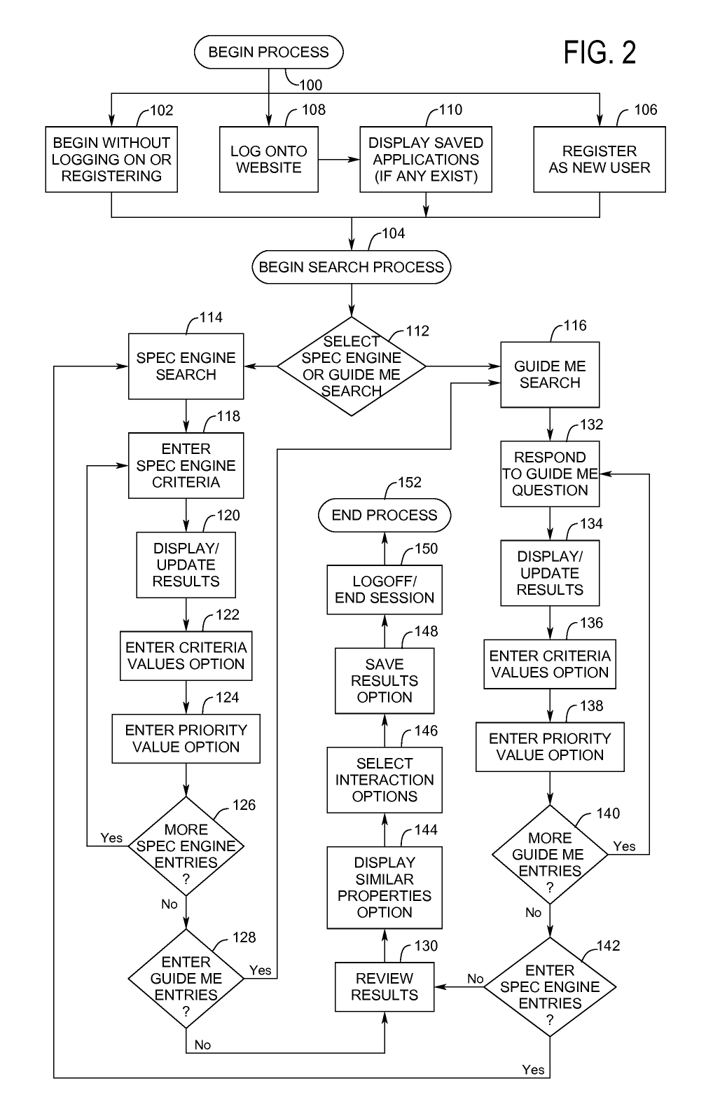

Referring now to FIG. 2, an overview of a method that may be used to implement the interactive expert system illustrated in FIG. 1 is shown. The process shown in FIG. 2 begins with a process initiation step 100, and then moves to one of three alternative steps associated with the user interface module 44 (shown in FIG. 1) and potentially the registered user interaction module 46 (shown in FIG. 1). The first of these alternative steps is a begin without logging on or registering step 102, in which a user accesses the interactive expert system through the user interface module 44 and chooses not to log on or register, in which case the process moves to a search process initiation step 104.

The second of these alternative steps is a register as new user step 106, in which a user elects to register as a new user, in which case the user will register on the website through the use of the registered user interaction module 46 (shown in FIG. 1), and user information (i.e., user name, address information, e mail address, etc.) will be stored in the user database 48, following which the process moves to the search process initiation step 104. The third of these alternative steps is a log onto website step 108 in which a registered user logs onto the interactive expert system through the use of the registered user interaction module 46, whereupon the process moves to a display saved applications step 110 in which information regarding the user's stored projects (if any) for particular chemicals searched will be retrieved from the project database 78 (shown in FIG. 1). If the user is not interested in such prior searches, the process them moves to the search process initiation step 104.

From the search process initiation step 104, the process next moves to a select spec engine or guide me search decision step 112 from which a user selects either a spec engine search step 114 (using the spec engine selection module 52 shown in FIG. 1) or a guide me search step 116 (using the guide me query module 54 shown in FIG. 1). From the spec engine search step 114, the process moves to an enter spec engine criteria step 118 where the user can enter key properties of chemical substances that they are attempting to identify using the spec engine selection module 52 (shown in FIG. 1). This is a two-step process, in which the user initially selects a property category (shown in all capital letters in TABLE 1 above) and then selects a property from the property category (shown following most of the property categories in an entry in TABLE 1). For example, the user can select “APPLICATION TYPE” as a property category, and then select “Bond” as the specific property type.

The process then moves to a display and/or update results step 120 in which results are displayed on the user computer 36 (shown in FIG. 1) by the output display module 74 (also shown in FIG. 1). It will be appreciated that if only a single property has been entered, a large number of results will be produced. At this point, for some properties, the user will have the option, in an enter criteria values option step 122, to enter values or ranges of values in the various properties of the material that the user is searching for. For example, for a property such as cure time a range of minutes (e.g., 10-30 minutes) may be entered; for a property such as low temperature resistance a range of temperatures (−40 to 0 degrees C.) may be entered; and for a property such as 1 part or 2 part material either choice may be made.

The process then moves to an enter priority value step 124, in which the user will have the option, for some properties, to indicate whether the selected property is required, optional, or excluded. Without the function of this enter priority value step 124, a selected property would always be a required property. This option enables a user to indicate that a specified property is desirable but not mandatory (optional), or that a specified property must be avoided. The indication that a specified property is optional will make the specified property less of a factor in the operation of the interactive expert system and method to identify recommended materials. The indication that a specified property is excluded will ensure that the interactive expert system and method will not provide any recommended materials that have this specified property.

The process then moves to a select more spec engine entries inquiry step 126 in which the user decides whether or not to enter further spec engine entries into the search. If the user decides to enter an additional spec engine entry, the process returns to the enter spec engine criteria step 118.

For example consider the user selecting “SUBSTRATE” as a spec engine category, and then selecting “Glass” as the specific spec engine entry type, and subsequently selecting “CURE DETAILS” as a spec engine category, and then selecting “Cure Time” as the specific spec engine entry type and further entering a range of 10 to 30 minutes, and subsequently selecting “Industry” as a spec engine category, and then selecting “Medical” as the specific spec engine entry type. Each of these questions further narrows the results of the search.

If, on the other hand, the user decides not to enter an additional spec engine entry in the select more spec engine entries inquiry step 126, the process then moves to an enter guide me entries inquiry step 128. In the enter guide me entries inquiry step 128, if the user decides not to respond to questions in the wizard mode, the process moves to a review results step 130 in which the user will review the results of the search process (which includes ranked results). If, on the other hand, the user decides to respond to questions in the guide me mode, the process moves to the guide me search step 116.

From the guide me search step 116, the process moves to a respond to guide me question step 132 where the user can enter key properties of chemical substances that the user is attempting to identify using the guide me query module 54 (shown in FIG. 1). This is a process of the user responding to questions provided by the interactive expert system, in which a series of questions are posed to the user. The questions provided to the user vary according to information previously entered by the user, and can include questions relating to some of the properties included in TABLE 1. An exemplary list of general topics for questions is provided in TABLE 2 above. For example, an introductory question could be a response to any one of a selection of Application Type, the Chemistry, the Substrate, a selected Manufacturer, or an End-Product category as a first response in using the guide me engine to search for the chemical substances that the user is attempting to identify.

The process then moves to a display and/or update results step 134 in which results are displayed on the user computer 36 (shown in FIG. 1) by the output display module 74 (also shown in FIG. 1). It will be appreciated that if only a single question has been responded to, a large number of results will be produced. At this point, for some properties, the user will have the option, in an enter criteria values option step 136, to enter values or ranges of values in the various properties of the material that the user is searching for. For example, for a property such as cure time a range of minutes (e.g., 10-30 minutes) may be entered; for a property such as low temperature resistance a range of temperatures (−40 to 0 degrees C.) may be entered; and for a property such as 1 part or 2 part material either choice may be made.

The process then moves to an enter priority value step 138, in which the user will have the option, for some properties, to indicate whether the selected property is required, optional, or excluded. Without the function of this enter priority value step 138, a selected property would always be a required property. This option enables a user to indicate that a specified property is desirable but not mandatory (optional), or that a specified property must be avoided. The indication that a specified property is optional will make the specified property less of a factor in the operation of the interactive expert system and method to identify recommended materials. The indication that a specified property is excluded will ensure that the interactive expert system and method will not provide any recommended materials that have this specified property.

The process then moves to a select more guide me questions inquiry step 140 in which the user decides whether or not to respond to further questions in the search. Generally, there will be between four and ten or more questions that may be responded to in order to narrow the search.

If the user decides to respond to an additional question, the process returns to the respond to guide me question step 132. For additional examples of guide me questions consider the items listed in Table 2, with questions potentially being formulated by the interactive expert system for each of these items. The new questions that will be asked by the interactive expert system and method depend upon both the response(s) to the previous questions(s), with the order of questions having an almost limitless number of different sequences depending upon the user's particular earlier response(s). One such example of a question may be “Will the material be subjected to” and the responses to the question could be “High Temperature,” “Low Temperature,” “Environmental Conditions,” “High Moisture/Humidity,” and “Chemicals.” The user can select any one (or for some questions more than one) response.

If, on the other hand, the user decides not to respond to an additional question in the select more guide me questions inquiry step 140, the process then moves to an enter spec engine entries inquiry step 142. In the enter spec engine properties inquiry step 142, if the user decides not to enter information into the spec engine mode, the process moves to the review results step 130 in which the user will review the results of the search process (which includes ranked results). If, on the other hand, the user decides to enter information into the spec engine mode, the process moves to the spec engine search step 114.

From reviewing the search results in the review results step 130, the process next moves to a display similar properties option step 144 which is implemented by the similar properties module 96 (shown in FIG. 1). If the display similar properties option step 144 is elected, the interactive expert system and method of the present invention will search for and identify one or more alternatives to the material for which the user has selected the display similar materials option, which alternative materials have the same properties as those of the selected material. It should be understood that the displayed alternative materials are selected using criteria specified by the interactive expert system rather than by the user, and thus will likely display different materials than those displayed as a result of the user's initial search.

The process next moves to a select interactions mode step 146, in which the user can request any of the options of the literature shipment module 80, the quote processing module 82, the sample shipment module 84, the sales call initiation module 86, the expert initiation module 88, and the demo initiation module 90, all of which are shown in FIG. 1.

Following the select interactions mode step 146, the process then moves to a save results option step 148 (which will only be available if the user is registered and has logged into the interactive expert system). From the save results option 148, the process next moves to a logoff/end session step 150 (which also will only be available if the user is registered and has logged into the interactive expert system), to allow the user to end the session by logging off of the interactive expert system. The interactive expert method then ends with a process termination step 152.

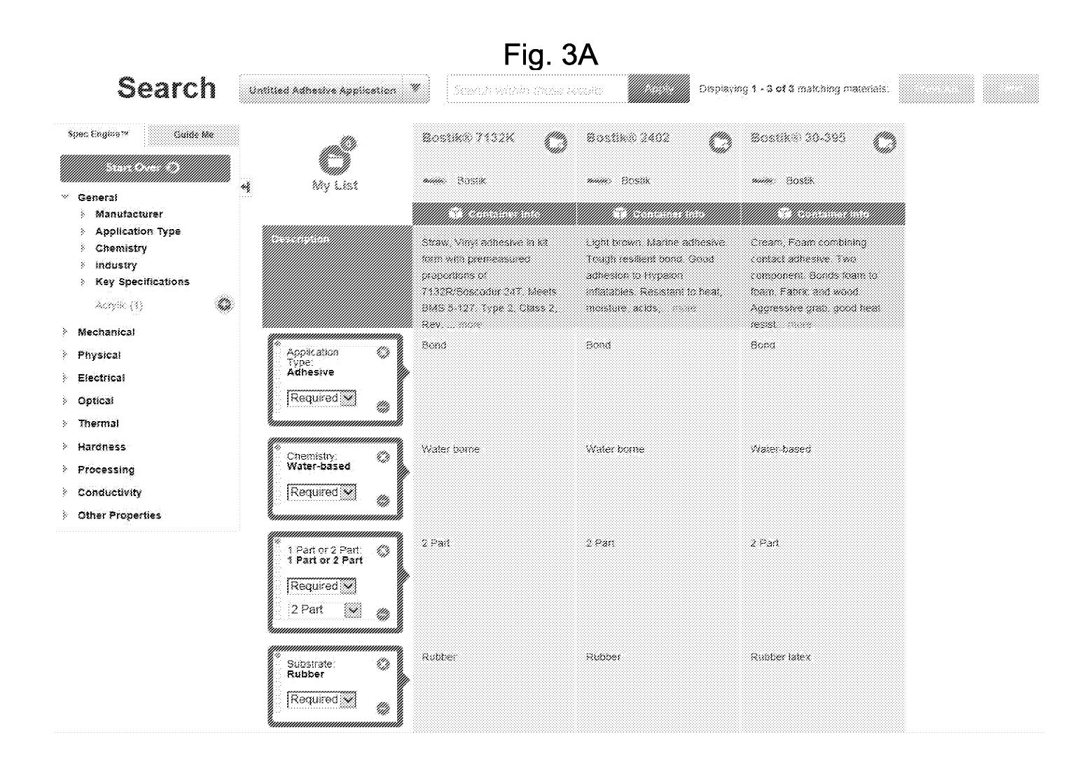

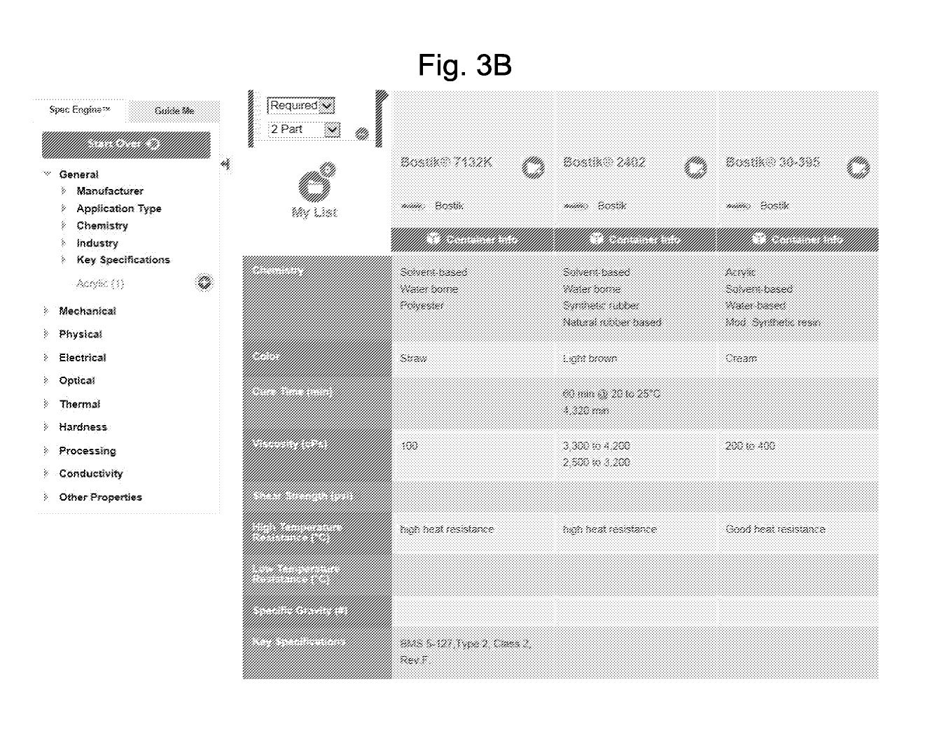

Referring next to FIGS. 3A and 3B, a screenshot produced according to the interactive expert system and method of the present invention is illustrated in the spec engine search mode (the spec engine search step 114, the enter spec engine criteria step 118, the display and/or update results step 120, the enter criteria values option step 122, the enter priority value option step 124, and the select more spec engine entries inquiry step 126 all shown in FIG. 2). There are a total of five columns shown in FIGS. 3A and 3B, with the left-most column being for the entry of spec engine categories (General, Mechanical, Physical, Electrical, Optical, Thermal, Hardness, Processing, Conductivity, and Other Properties are shown) and properties (Under the General property category, Manufacturer, Application Type, Chemistry, Industry, and Key Specification are shown).

The second column from the left shows the search criteria that have been specified, namely Application Type: Adhesive; Chemistry: Water Based; 1 Part or 2 Part: 2 Part Required; and Substrate: Rubber. The next three columns show the three results, with the chemical name, manufacturer, and summary information being located at the top of each of the three columns, and information for each of the four criteria for each result being shown on lines corresponding to the search criteria.

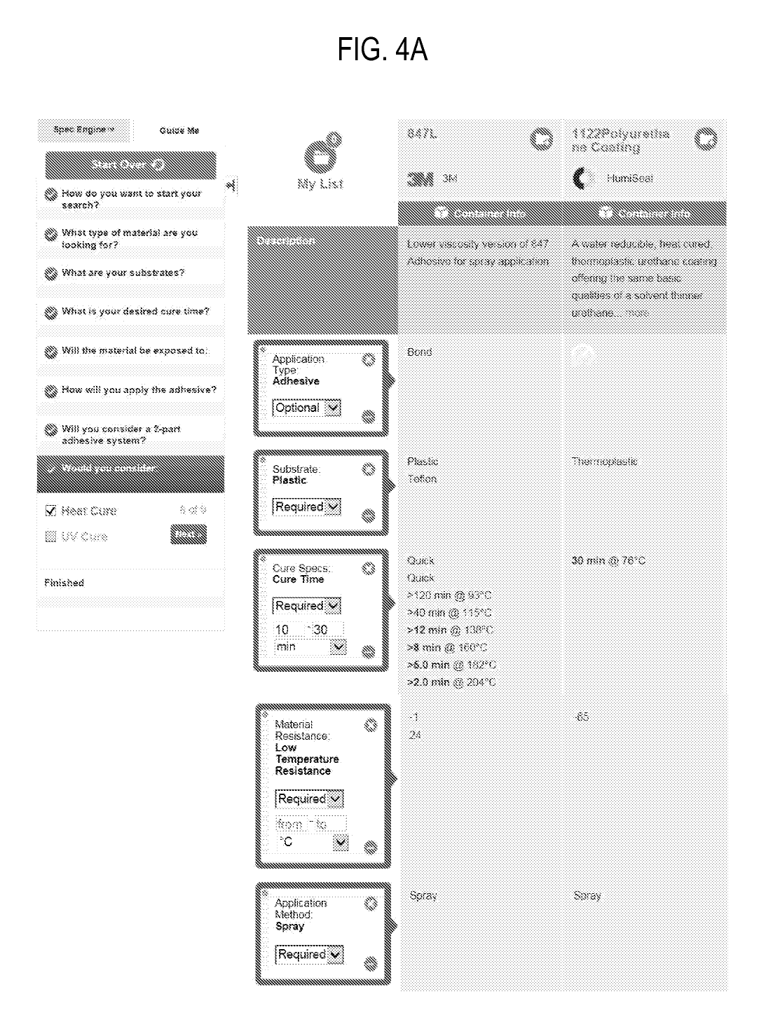

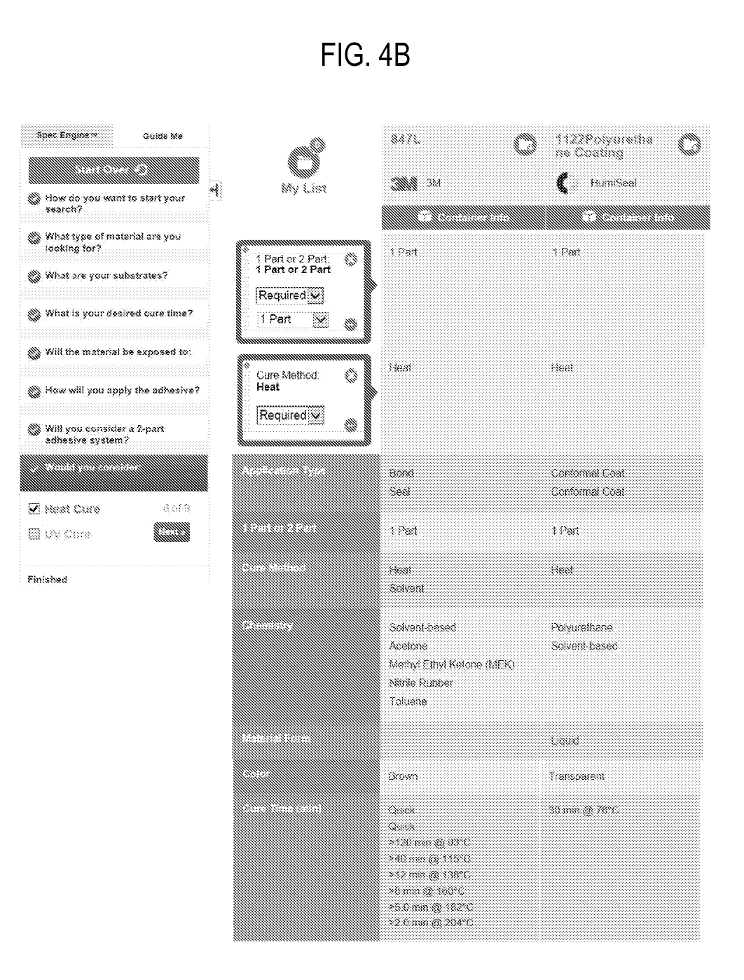

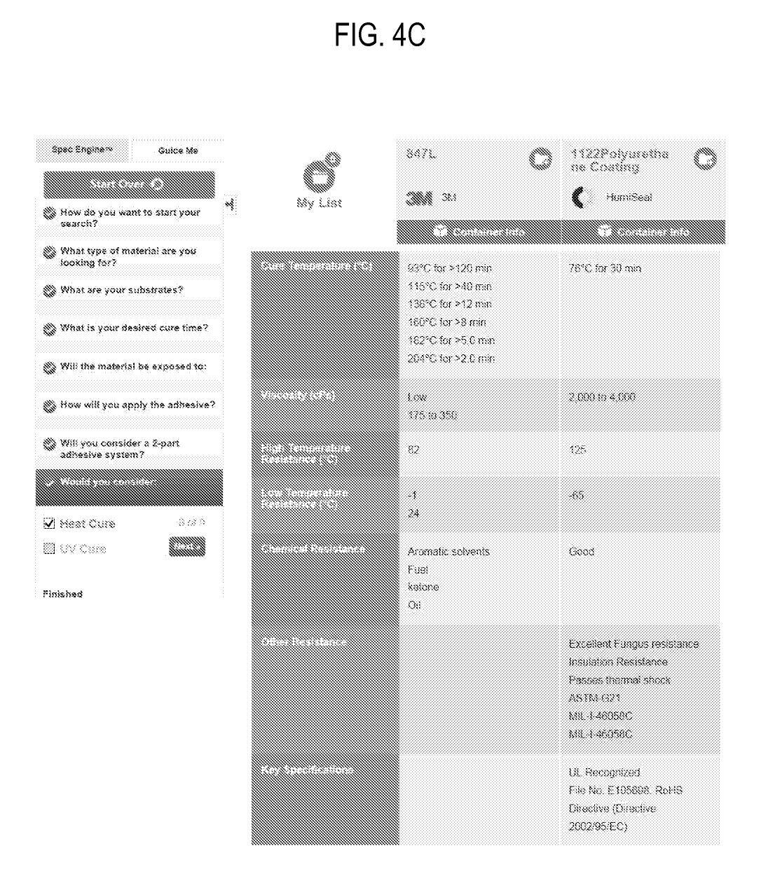

Referring now to FIGS. 4A, 4B, and 4C, a screenshot produced according to the interactive expert system and method of the present invention is illustrated in the guide me search mode (the guide me search step 116, the respond to guide me question step 132, the display and/or update results step 134, the enter criteria values option 136, the enter priority value option step 138, and the select more guide me questions inquiry step 140 all shown in FIG. 2). The screenshot of FIGS. 4A, 4B, and 4C includes different criteria from those selected in the screenshot of FIG. 3, and has a response to the guide me questions. There are a total of only four columns shown in FIGS. 4A, 4B, and 4C, with the left-most column being for the entry of responses to one of the guide me questions (Would you consider Heat Cure) with potential response being (Required, Optional, Exclude).

The second column from the left shows the responses to seven guide me questions that have been specified, including the selected response to the last guide me question (Would you consider Heat Cure). The next two columns show the only results with the chemical name, manufacturer, and summary information being located at the top of the two columns, and information for each of the responses to the seven guide me questions for the results being shown on lines corresponding to the search criteria.

The operation of the criteria values entry module 92 (shown in FIG. 1), in either of the enter criteria values option step 122 and the enter criteria values option 136 (both shown in FIG. 2), may be described with reference to both FIG. 3A and FIG. 4B in the search property “1 Part or 2 Part” where the user may limit the material being sought to 1 part materials or 2 part materials. Referring now to FIG. 4A, a cure time range can be specified (10 minutes to 30 minutes is shown in FIG. 4A). Also in FIG. 4A, if desired the user could specify the temperature range that would be acceptable in the Material Resistance: Low Temperature Resistance search property (although no temperature range is entered therein in FIG. 4A).

The operation of the priority data input module 94 (shown in FIG. 1), in either of the enter priority value option step 124 and the enter priority value option step 138 (both shown in FIG. 2), may be described with reference to both FIG. 3A and FIGS. 4A and 4B in the priority modification of the search property. For each of the selected search criteria, the user will have the option to indicate whether the selected property is “Required,” or “Optional,” or “Excluded.” This represents a significant improvement since otherwise the selected property is always “Required.” Using the priority option, the user may thus use the “Exclude” priority option to specify that the material being sought does not have the named property. Further, if the “Optional” priority option is used by the user, the importance of the named property for the material that the user is searching for may be diminished from its importance if it was “Required.”

It should also be understood that a user may use both the spec engine mode discussed above with respect to FIGS. 3A and 3B and the guide me mode discussed above with respect to FIGS. 4A, 4B, and 4C to provide information used to identify a chemical substance that the user is attempting to ascertain. The user may start with either mode to enter information and then move to the other mode to enter information, thereby using the features of both modes.

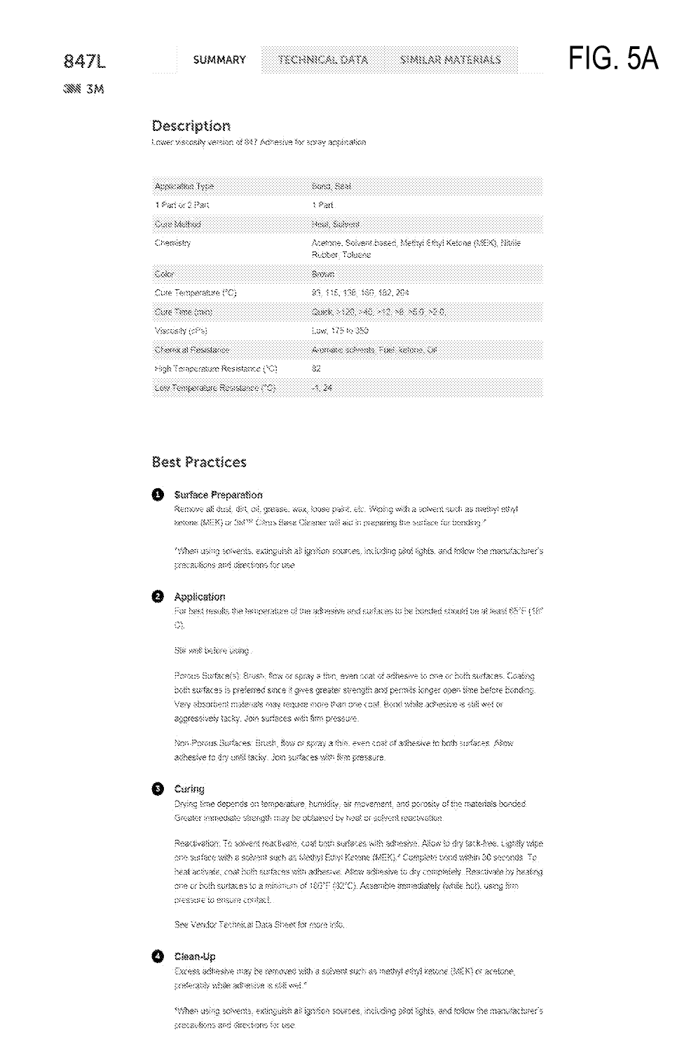

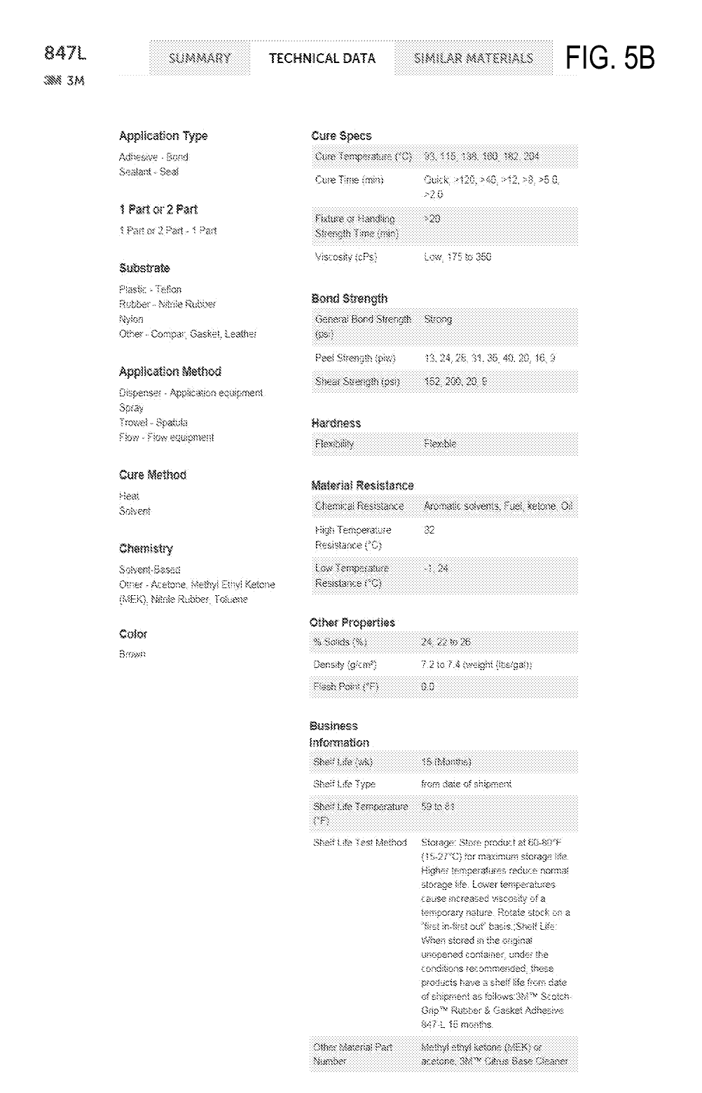

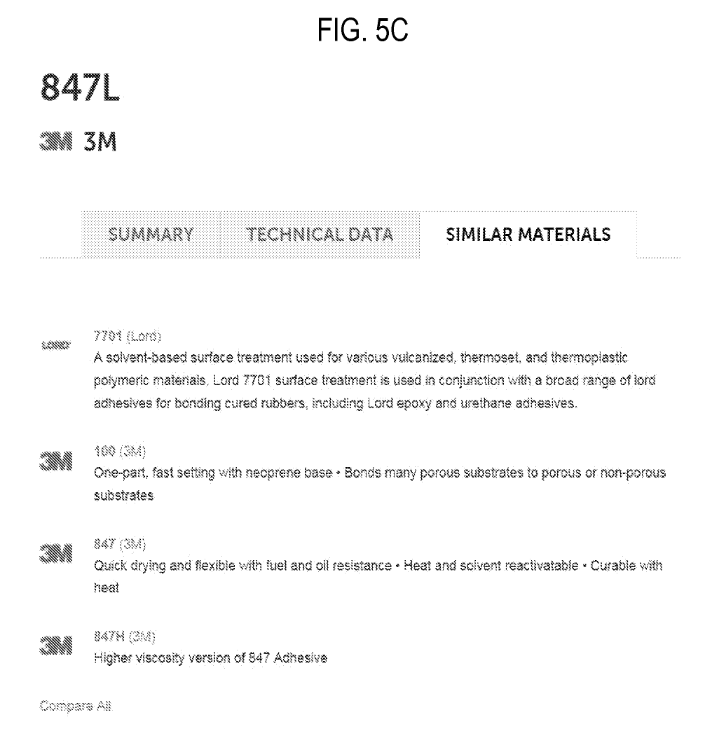

Referring next to FIG. 5A, the first of three screenshots for a selected material located in the searches performed by a user is provided in which summary information for the chosen material is provided to the user by the review results step 130 (also shown in FIG. 2). Referring now to FIG. 5B, the second of three screenshots for a selected material located in the searches performed by a user is provided in which technical data information is provided to the user by the review results step 130 (shown in FIG. 2).

Referring now to FIG. 5C, the third of three screenshots for a selected material located in the searches performed by a user is provided in which similar materials is provided to the user through the operation of the similar properties module 96 (shown in FIG. 1) in the display similar properties option step 144 (shown in FIG. 2). The similar materials shown are selected using criteria specified by the interactive expert system rather than the criteria that were provided by the user in locating the material for which similar materials are being sought.

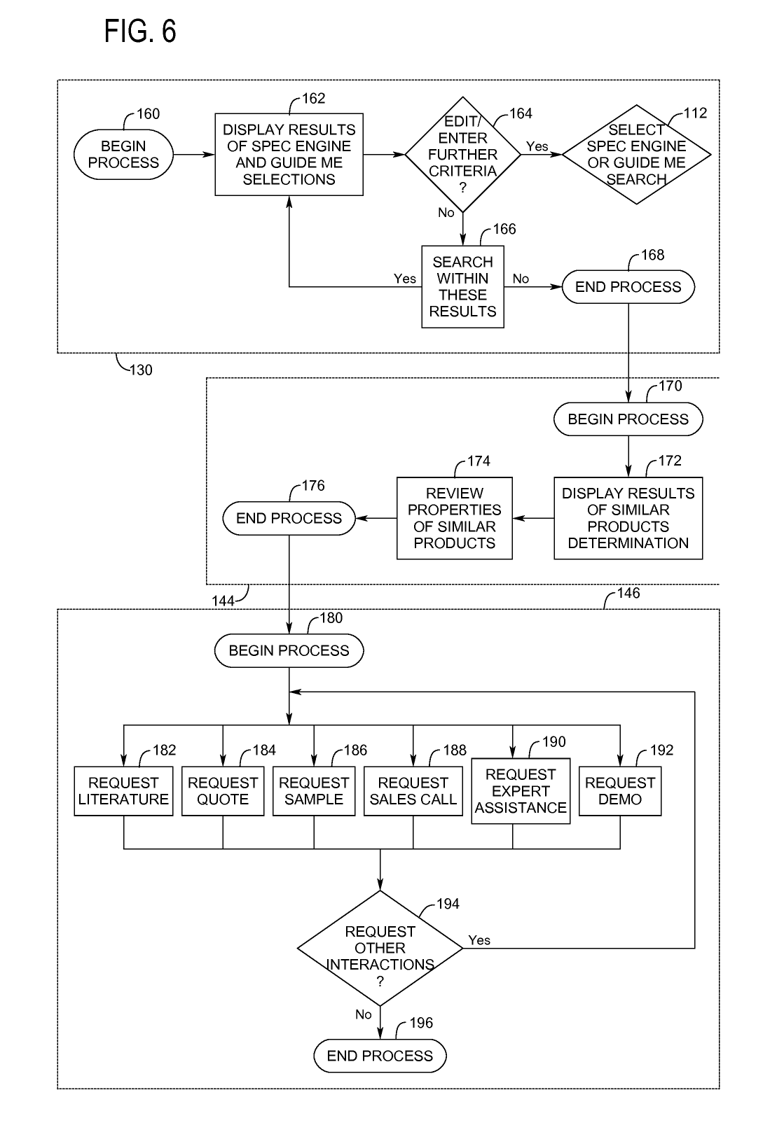

Referring next to FIG. 6, the review results step 130, the display similar properties option step 144, and the select interactions mode step 146 of FIG. 2 are shown in somewhat expanded detail. The review results step 130 begins with a process initiation step 160 from which the process moves to a display results of spec engine and guide me selections step 162 in which the user views the ranked displayed results regarding the recommended chemicals fitting the user's requirements. The process next moves to an edit search logic or enter further search criteria decision step 164, from which the user has the option of further revising the search criteria by selecting additional properties or responding to additional questions. If the user elects to do so, the process moves to the select spec engine or guide me search decision step 112 (best shown in FIG. 2). On the other hand, if the user does not choose to do so, the process moves instead to an optional search within these results step 166.

In the search within these results step 166, the user may add an additional search term that will be applied to all of the products identified as meeting the search results, excluding those that do not meet this additional criteria. Referring for the moment to FIG. 3A, this place to enter an additional criteria can be seen on the top center of the screen. Additionally, it may be seen that above the right-most of the five columns shown is a “Next” button which can be used to view additional results meeting the search criteria. While in FIG. 3 there are only three results, it is possible that there are more results than could be shown in the screen without using the “Next” button to view the additional search results (and also using a “Previous” button to move to the more relevant results once the “Next” button has been so used).

By checking executing a search within the existing search results, the user will return the process to the display results of spec engine and guide me selections step 162. If, on the other hand, the user does not execute a search within the existing search results, the process instead moves to a process termination step 168.

From the process termination step 158 completing the review results step 126, the process moves next to a process initiation step 170 in the display similar properties option step 144. From there, the user may optionally select one of the products included in the search results and elect to display products that are similar to the product from the search results in a display results of similar products determination step 172. While the initial search results are based upon user input consisting essentially of specific characteristics of the products, the identification of similar products is based upon criteria established by the interactive expert system and method which are performed by the similar properties module 96 (shown in FIG. 1). Similar products are then displayed in a review properties of similar products step 176. The process then moves to a process termination step 178.

From the process termination step 178 completing the display similar properties option step 144, the process moves to a process initiation step 180 in the select interactions mode step 146. From there, the user may select any of six options, namely: request that selected ones of the search results be e-mailed or mailed to the user or the user's designee in a request literature step 182 (that is performed by the literature shipment module 80 shown in FIG. 1, and is identified as a “Share” function in FIGS. 3 and 4); request that a quote on selected ones of the search results either be printed or e-mailed or mailed to the user or the user's designee in a request quote step 184 (that is performed by the quote processing module shown in FIG. 1); request that a sample of a selected one of the search results be shipped to the user or the user's designee in a request sample step 186 (that is performed by the sample shipment module 84 shown in FIG. 1); request that a sales call from a representative of the operator of the interactive expert system or a representative of the chemical manufacturer call on the user or the user's designee in a request sales call step 188 (that is performed by the sales call initiation module 86 shown in FIG. 1); request expert assistance from an expert employed by the operator of the interactive expert system be provided to the user in a request expert assistance step 190 (that is performed by the expert initiation module 88 shown in FIG. 1); or request a product demonstration from a representative of the operator of the interactive expert system or a representative of the chemical manufacturer in a request demonstration step 192 (that is performed by the demo initiation module 90 shown in FIG. 1).

Following the performance of any of these steps, the process then moves to a request other interactions decision step 194 where the user can either terminate the select interactions mode step 136 in a process termination step 196, or decide to request other interactions. If the user requests other interactions in the request other interactions decision step 194, the process then would return to a point just after the process initiation step 180, from which any of the other interactions may be initiated.

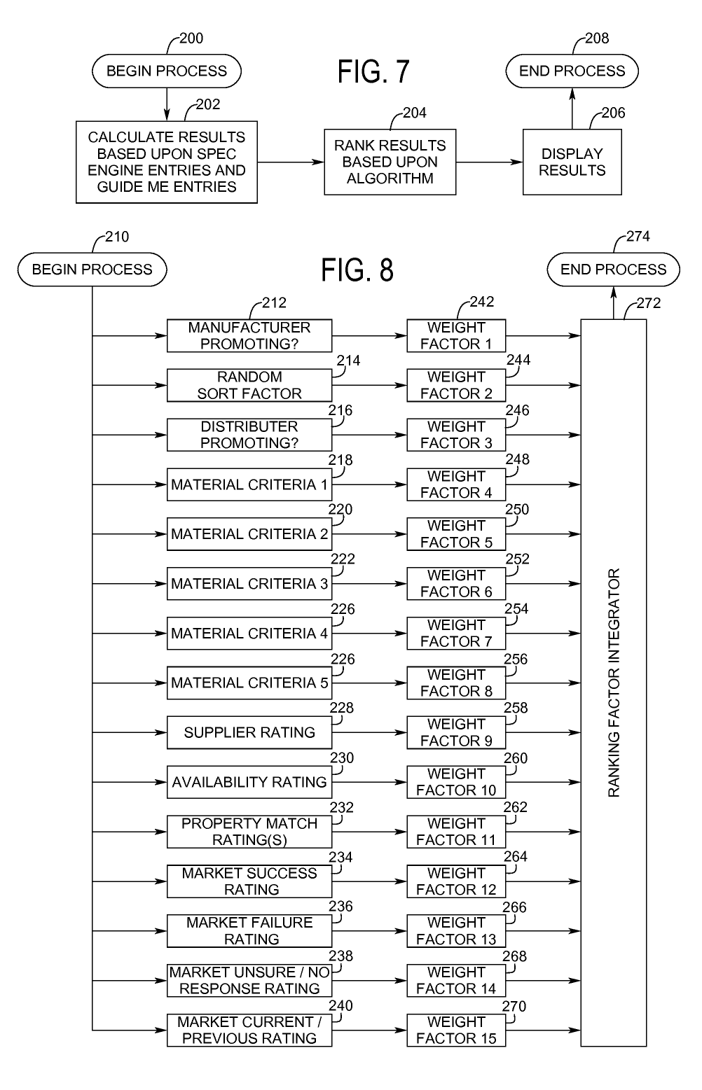

Turning next to FIG. 7, an overview of a process that may be used by the ranking module 66 (shown in FIG. 1) of the interactive expert system prior to displaying the search results is shown. From a process initiation step 200, the process moves to a calculate results based upon user entries step 202 in which the user's key desired chemical product characteristics and/or specific application requirements for the desired chemical product are used to produce a subgroup of the chemical products that meet these user criteria (this is performed by the product identification module 62 shown in FIG. 1). Depending upon the criteria entered by the user, there may be a larger number of chemical products that would make review of the results difficult or time-consuming.

Accordingly, after the calculate results based upon user entries step 202 is performed, the process moves to a rank results step 204 in which the interactive expert system uses an algorithm to organize the search results in a priority from most relevant to least relevant. After the search results are ranked in the rank results step 204, the process moves to a display results step 206 in which the ranked results of the search are displayed (this is performed by the output display module 74 shown in FIG. 1). From there, the process shown in FIG. 6 moves to a process termination step 208, where it ends.

Referring now to FIG. 8, an overview of an exemplary implementation of a ranking algorithm utilizing a number of ranking factors and a correlating number of weight factors to rank the search results based upon the user's key desired chemical product characteristics and/or specific application requirements for the desired chemical product. From a process initiation step 210, the process moves to a determination of a plurality of ranking factors for each of the chemical products identified by the user's search criteria, with each factor being multiplied by a weighting factor remaining the same for all of the chemical products identified by the user's search criteria. The results are added for each of the chemical products identified by the user's search criteria to produce a single number, and the chemical products identified by the user's search criteria are ranked from the highest sum (highest ranked) to the lowest sum (lowest ranked).

In the exemplary embodiment of the ranking algorithm shown in FIG. 8 each chemical product has fifteen ranking factors with unique individualized values for each of these ranking factors being established for each of tens of thousands of chemical products. It will be appreciated that fewer or more ranking factors could be used without departing from the spirit of the present invention. These ranking factures include: a manufacturer promoting? ranking factor 212, a random sort factor ranking factor 214, a distributor promoting? ranking factor 216, first, second, third, fourth, and fifth material criteria ranking factors 218, 220, 222, 224, and 226, respectively, a supplier rating ranking factor 228, an availability rating ranking factor 230, a property match rating(s) ranking factor 232, a market success rating ranking factor 234, a market failure rating ranking factor 236, a market uncertainty ranking factor 238, and a market current/previous rating ranking factor 240.

A brief summary of each of these ranking factors, which in a preferred embodiment can have a value from zero to ten, will be provided in the following paragraphs. The manufacturer promoting? ranking factor 212 is an indication of whether or not a manufacturer is actively promoting a product; for example, a discontinued product would have a value of zero and a highly promoted product would have a value of ten. The random sort factor ranking factor 214 is a random sorting value from zero to ten that is randomly assigned to chemical products in order to prevent two chemical products having identical values for all of their other ranking factors from having an identical total score. The distributor promoting? ranking factor 216 is an indication of whether or not the distributor operating the interactive expert system is actively promoting a product; for example, a product that is very difficult to source could have a value of zero and a popular, readily available, highly promoted product could have a value of ten.

The first, second, third, fourth, and fifth material criteria ranking factors 218, 220, 222, 224, and 226, respectively, are criteria that are based upon each chemical material's popularity in the interactive expert system. For example, the first material criteria ranking factor 218 could be based upon the number of page clicks that each chemical product has; the second material criteria ranking factor 220 could be based upon the number of times each chemical product's literature is printed or requested to be e-mailed or mailed to a user; the third material criteria ranking factor 222 could be based upon the number of times each chemical product's literature is requested to be e mailed or mailed to another person identified by the user (shared); the fourth material criteria ranking factor 224 could be based upon the number of times a sample is requested of each chemical product; and the fifth material criteria ranking factor 226 could be based upon the number of times a quote is requested for each chemical product.

The supplier rating ranking factor 228 is an indication of the quality or reputation of the supplier of each chemical product. The availability rating ranking factor 230 is an indication of the ease and speed of obtaining a patent; for example, a product that is in stock could have a value of ten and a back-ordered product could have a substantially lower value.

The property match rating(s) ranking factor 232 is an indication of the chemical product exactly matching key desired chemical product characteristics and/or specific application requirements that have been specified by a user. This is the only one of the ranking factors that can have a value of over ten, since each chemical product characteristic or specific application requirement that is exactly matched will be given a ten, so a chemical product matching three characteristics or requirements would have a value of thirty, while a chemical product matching no characteristic or requirement would have a value of zero. The property match rating(s) ranking factor 232 thus has a different effect on the numerical score of each of the chemical products than the other ranking factors which are preset for each of the chemical products in the product information database 64 (shown in FIG. 1).

The market success rating ranking factor 234, the market failure rating ranking factor 236, the market uncertainty ranking factor 238, and the market current/previous rating ranking factor 240 are indications of a chemical product's market success, market failure, uncertainty (such as a brand new product), and an upward or downward trend in a chemical product's rating, respectively. Desirable or positive scores are ten at the high end, while undesirable scores for these market-related ranking factors are zero at the low end. These four ranking factors, like the property match rating(s) ranking factor 232, have different effects on the numerical score of each of the chemical products than the other ranking factors, and like any of the other ranking factors, are optional, but are included in the exemplary embodiment.

The manufacturer promoting? ranking factor 212, the random sort factor ranking factor 214, the distributor promoting? ranking factor 216, the first, second, third, fourth, and fifth material criteria ranking factors 218, 220, 222, 224, and 226, respectively, the supplier rating ranking factor 228, the availability rating ranking factor 230, the property match rating(s) ranking factor 232, the market success rating ranking factor 234, the market failure rating ranking factor 236, the market uncertainty ranking factor 238, and the market current/previous rating ranking factor 240 are each associated with relative weighting factors 242, 244, 246, 248, 250, 252, 254, 256, 258, 260, 262, 264, 266, 268, or 270, respectively. The relative weighting factors 242, 244, and 246 may be, for example, 0.5, 3, and 1, respectively. Each of the relative weighting factors 248, 250, 252, 254, and 256 may be, for example, 0.2. The relative weighting factors 258, 260, and 262 may be, for example, 0.5, 1, and 2, respectively. The relative weighting factors 264, 266, 268, and 270 may each be, for example, 0.25. Obviously, each of these relative weighting factors can be varied considerably without departing from the spirit of the present invention.

Once each of the manufacturer promoting? ranking factor 212, the random sort factor ranking factor 214, the distributor promoting? ranking factor 216, the first, second, third, fourth, and fifth material criteria ranking factors 218, 220, 222, 224, and 226, respectively, the supplier rating ranking factor 228, the availability rating ranking factor 230, the property match rating(s) ranking factor 232, the market success rating ranking factor 234, the market failure rating ranking factor 236, the market uncertainty ranking factor 238, and the market current/previous rating ranking factor 240 have been multiplied by the relative weighting factors 242, 244, 246, 248, 250, 252, 254, 256, 258, 260, 262, 264, 266, 268, or 270, respectively, the totals will be provided to a ranking factor integrator 272, which will add them for each chemical product, and rank the chemical products from the highest total to the lowest total. From there, the process shown in FIG. 8 moves to a process termination step 274, where it ends.

This controls the display order of the ranked chemical products matching the search criteria selected by a user as displayed by the output display module 74 (shown in FIG. 1), with the highest ranked chemical products being displayed first (to the left as shown in FIGS. 3A and 3B, and in FIGS. 4A, 4B, and 4C). Optionally, the numerical score of each of the chemical products matching the search criteria could also be displayed by the output display module 74 to users of the system and method to assist users in the selection of chemical products.

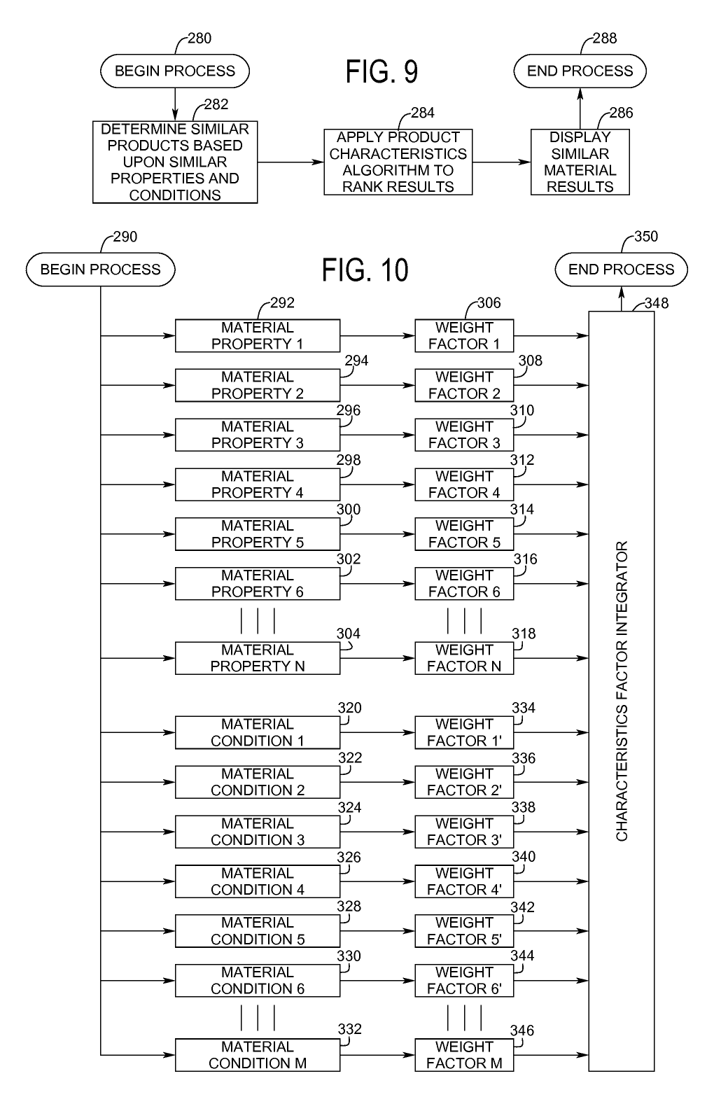

Referring next to FIG. 9, an overview of a process that may be used by the similar properties module 96 (shown in FIG. 1) of the interactive expert system to determine and display the similar materials is shown. From a process initiation step 280, the process moves to a determine similar products based upon similar properties and conditions step 282 in which the similar products are identified by the interactive expert system and method. The similar materials so identified are then ranked in a apply product characteristics algorithm step 284. The top-ranked similar materials are then displayed to the user (as shown in FIG. 5C) in a display results step 286. The process then terminates in a process termination step 288.

Referring finally to FIG. 10, an overview of an exemplary implementation of an algorithm utilizing a number of ranking factors and a correlating number of weight factors to select and rank similar materials based upon the material located by and selected for an identification of similar products by the user. From a process initiation step 290, the process moves to a determination of a plurality of material properties and a plurality of material conditions for the chemical products selected by the user, with each factor being multiplied by a weighting factor remaining the same for all of the potential similar products identified by the interactive expert system and method. The results are added for each of the chemical products identified as a potential similar product to produce a single number, and the chemical products identified by this process are ranked from the highest sum (highest ranked similar product) to the lowest sum (lowest ranked similar product).

In the exemplary embodiment of the similar product algorithm shown in FIG. 10 each chemical product has N material properties with unique individualized values for each of these material properties and M material conditions with unique individualized values for each of tens of thousands of chemical products. The material properties include: a first material property ranking factor 292, a second material property ranking factor 294, a third material property ranking factor 296, a fourth material property ranking factor 298, a fifth material property ranking factor 300, a sixth material property ranking factor 302, up to an Nth material property ranking factor 304. In a preferred embodiment, each of the material properties can have a value from zero to ten. The particular material properties used by the interactive expert system and method are chosen by the provider of the interactive expert system and method.

Each of the particular material properties is associated with a relative weighting factor. Thus, the first material property ranking factor 292, the second material property ranking factor 294, the third material property ranking factor 296, the fourth material property ranking factor 298, the fifth material property ranking factor 300, the sixth material property ranking factor 302, up to the Nth material property ranking factor 304 are respectively associated with a first weighting factor 306, a second weighting factor 308, a third weighting factor 310, a fourth weighting factor 312, a fifth weighting factor 314, a sixth weighting factor 316, and an Nth weighting factor 318. The relative weighting factors 306, 308, 310, 312, 314, 316, and 318 may be, for example, any value between 0. and 1. Obviously, each of these relative weighting factors can be varied considerably without departing from the spirit of the present invention.

The material conditions include: a first material condition ranking factor 320, a second material condition ranking factor 322, a third material condition ranking factor 324, a fourth material condition ranking factor 326, a fifth material condition ranking factor 328, a sixth material condition ranking factor 330, and an Nth material condition ranking factor 332. In a preferred embodiment, each of the material conditions can have a value from zero to ten. The particular material conditions used by the interactive expert system and method are chosen by the provider of the interactive expert system and method.

Each of the particular material conditions is also associated with a relative weighting factor. Thus, the first material condition ranking factor 320, the second material condition ranking factor 322, the third material condition ranking factor 324, the fourth material condition ranking factor 326, the fifth material condition ranking factor 328, the sixth material condition ranking factor 330, and the Nth material condition ranking factor 332 are respectively associated with a first′ weighting factor 334, a second′ weighting factor 336, a third′ weighting factor 338, a fourth′ weighting factor 340, a fifth′ weighting factor 342, a sixth′ weighting factor 344, and an Mth weighting factor 346. The relative weighting factors 334, 336, 338, 340, 342, 344, and 346 may be, for example, any value between 0. and 1. Obviously, each of these relative weighting factors can be varied considerably without departing from the spirit of the present invention.

Once each of the material property ranking factors 292, 294, 296, 298, 300, 302, and 304, and the material condition ranking factors 320, 322, 324, 326, 328, 330, and 332 have been multiplied by the relative weighting factors 306, 308, 310, 312, 314, 316, 318, 334, 336, 338, 340, 342, 344, and 346, respectively, the totals will be provided to a characteristics factor integrator 348, which will add them for each similar product, and rank the similar products from the highest total to the lowest total. From there, the process shown in FIG. 10 moves to a process termination step 350, where it ends.

It may therefore be appreciated from the above detailed description of the exemplary embodiment of the present invention that it provides a system and method to assist users in the selection of chemical products from the extremely large number of chemical products that are available on the market based upon key desired chemical product characteristics and specific application requirements for the desired chemical product that are provided by the users. The interactive expert system and method of the present invention are both easy to use and relatively quick to identify appropriate candidates for the product sought by a user. The interactive expert system and method of the present invention utilize a ranking system that intelligently ranks the results of searching based upon the desired chemical product characteristics and the specific application requirements to order the search results depending on the specific requirements that have been entered by the user. Finally, the interactive expert system and method of the present invention achieves numerous advantages without incurring any substantial relative disadvantage.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be claimed alone or in combination with any of the features, elements, or components of any of the other embodiments discussed above.

What is claimed is:

1. An interactive system for providing ranked specific chemical product recommendations to a user of the interactive system, comprising:
a user interface module that is arranged and configured to facilitate the entry of information by a user to the interactive system;
a spec engine module operatively connected to the user interface module that is arranged and configured to prompt the input, by the user, of required, optional, or excluded properties of a chemical substance that the user is attempting to ascertain;
a guide me module operatively connected to the user interface module that is arranged and configured to prompt the input, by the user, of responses to questions presented by the guide me module which responses are indicative of application requirements for required, optional, or excluded properties of a chemical substance that the user is attempting to ascertain;
an integration module operatively connected to the spec engine module and the guide me module that is arranged and configured to provide a group of recommended chemical substances that are responsive to the required, optional, or excluded properties and the responses to questions provided by the user;
a ranking module operatively connected to the integration module that is arranged and configured to rank the group of recommended chemical substances in a preferred order from first to last; and
an output module operatively connected to the ranking module that is arranged and configured to facilitate the display, to the user, of the ranked group of recommended chemical substances in the preferred order from first to last.

2. An interactive system as defined in claim 1, additionally comprising:
a criteria values entry module operatively connected to the user interface module and the integration module to facilitate the entry of criteria by the user to modify selected properties selected by the user by specifying a range of values for each such selected property that must be met by the recommended chemical substances provided by the integration module.

3. An interactive system as defined in claim 1, wherein the spec engine module and the guide me module are arranged and configured to allow the user to select either the spec engine module to allow the user to input desired properties of a chemical substance that the user is attempting to ascertain, or the guide me module operatively connected to the user interface module to allow the user to input responses to questions presented by the guide me module which responses are indicative of application requirements of a chemical substance that the user is attempting to ascertain, or to use both the spec engine module and the guide me module to provide information used to identify a chemical substance that the user is attempting to ascertain.

4. An interactive system as defined in claim 1, additionally comprising:
a property group database operatively connected to the spec engine module that contains a number of different property categories; and
a properties database operatively connected to the spec engine module that contains pluralities of properties associated with each of the various properties categories of the property group database; wherein the spec engine module is arranged and configured to allow the user to select a properties category and subsequently select a property associated with the selected properties categories.

5. An interactive system as defined in claim 1, additionally comprising:
a question database operatively connected to the guide me module that contains a number of different questions;
wherein the guide me module is arranged and configured to allow the present questions based at least in part upon information previously provided by the user to the guide me module and/or the spec engine module.

6. An interactive system as defined in claim 1, wherein the integration module comprises:
a product information database that contains information for a large number of different chemical products representing chemical products available to the interactive system for recommendation; and
a product identification module operatively connected to the product information database that is arranged and configured to search the product information database to locate chemical products that meet the desired properties and the responses to the questions provided by the user.

7. An interactive system as defined in claim 6, wherein the product information database is operatively connected to the output module to provide information from the product information database associated with each of the recommended chemical substances in the ranked group of recommended chemical substances to the display module for display to the user.

8. An interactive system as defined in claim 1, additionally comprising:
a vendor information database that contains vendor information for chemical products available to the interactive system for recommendation;
wherein the vendor information database is operatively connected to the output module to provide vendor information from the vendor information database associated with each of the recommended chemical substances in the ranked group of recommended chemical substances to the display module for display to the user.

9. An interactive system as defined in claim 1, wherein the ranking module uses an algorithm to organize the search results in a priority from most relevant to least relevant.

10. An interactive system as defined in claim 9, additionally comprising:
a ranking criteria database operatively connected to the ranking module that contains categories of ranking criteria used to arrange the ranking of recommended chemicals and relative weighting factors for each of these ranking criteria; and
a ranking criteria information database operatively connected to the ranking module that contains values for each of the ranking criteria for each of the recommended chemical substances.

11. An interactive system as defined in claim 1, additionally comprising:
an Internet server that is arranged and configured to facilitate communication to and from a computer used by the user to access:
the user interface module of the interactive system to thereby facilitate the use of the computer used by the user to enter information into the interactive system; and
the output module of the interactive system to thereby facilitate the use of the computer used by the user to display information from the interactive system.

12. An interactive system as defined in claim 1, additionally comprising:
a priority data input module operatively connected to the user interface module and the product integration module that is arranged and configured to facilitate the user to elect whether a selected property of a chemical substance that the user is attempting to ascertain is required, or optional, or excluded.

13. An interactive system as defined in claim 1, wherein an election by the user that a selected property is required will ensure that all recommended chemical substances have the specified property, an election by the user that a selected property is optional will diminish the importance of the selected product in the identification of recommended chemical substances by the integration module, and an election by the user that a selected property is excluded will ensure that all recommended chemical substances do not have the specified property.

14. An interactive system as defined in claim 1, additionally comprising:
a similar properties module operatively connected to the ranking module that is arranged and configured to provide the user with a list of similar chemicals for any selected one of the recommended chemicals identified by the interactive system.

15. An interactive system as defined in claim 14, wherein the similar properties module is arranged and configured such that the recommended chemicals identified in the search are based upon the properties specified by a user, and wherein the similar chemicals identified by the similar properties module for any selected one of the recommended chemicals is based upon criteria specified by the interactive system.

16. An interactive system for providing ranked specific chemical product recommendations to a user of the interactive system, comprising:
a user interface module that is arranged and configured to facilitate the entry of information by a user to the interactive system;
a spec engine module operatively connected to the user interface module that is arranged and configured to prompt the input, by the user, of required, optional, or excluded properties of a chemical substance that the user is attempting to ascertain;
a property group database operatively connected to the spec engine module that contains a number of different property categories;
a properties database operatively connected to the spec engine module that contains pluralities of properties associated with each of the various properties categories of the property group database;
wherein the spec engine module is arranged and configured to allow the user to select a properties category and subsequently select a property associated with the selected properties categories;
a guide me module operatively connected to the user interface module that is arranged and configured to prompt the input, by the user, of responses to questions presented by the guide me module which responses are indicative of application requirements for required, optional, or excluded properties of a chemical substance that the user is attempting to ascertain;
a question database operatively connected to the guide me module that contains a number of different questions;
wherein the guide me module is arranged and configured to allow the present questions based at least in part upon information previously provided by the user to the guide me module and/or the spec engine module;
an integration module operatively connected to the spec engine module and the guide me module that is arranged and configured to provide a group of recommended chemical substances that are responsive to the required, optional, or excluded properties and the responses to questions provided by the user;
a ranking module operatively connected to the integration module that is arranged and configured to rank the group of recommended chemical substances in a preferred order from first to last;
an output display module operatively connected to the ranking module that is arranged and configured to facilitate the display, to the user, of the ranked group of recommended chemical substances in the preferred order from first to last; and
a similar properties module operatively connected to the ranking module that is arranged and configured to provide the user with a list of similar chemicals for any selected one of the recommended chemicals identified by the interactive system.

17. An interactive system for providing chemical product recommendations to a user, comprising:
at least one data acquisition module configured to prompt the input, by the user, of at least one of:
required, optional, or excluded properties of a chemical substance that the user is attempting to ascertain; and
a response to at least one question presented by the at least one data acquisition module which responses are indicative of application requirements for required, optional, or excluded properties of a chemical substance that the user is attempting to ascertain;
wherein the at least one data acquisition module is configured to provide a group of recommended chemical substances that are responsive to the required, optional, or excluded properties and/or the responses to questions provided by the user;
a ranking module configured to rank the group of recommended chemical substances in a preferred order from first to last; and
an output module configured to facilitate the display, to the user, of the ranked group of recommended chemical substances in the preferred order from first to last.

18. An interactive system as defined in claim 17, additionally comprising:
a similar properties module operatively connected to the ranking module that is arranged and configured to provide the user with a list of similar chemicals for any selected one of the recommended chemicals identified by the interactive system.

19. A method for providing ranked specific chemical product recommendations to a user, comprising:
facilitating the entry of information by a user with a user interface module;
with a spec engine module operatively connected to the user interface module, prompting the input, by the user, of required, optional, or excluded properties of a chemical substance that the user is attempting to ascertain;
with a guide me module operatively connected to the user interface module, prompting the input, by the user, of responses to questions generated by a guide me module which responses are indicative of application requirements for required, optional, or excluded properties of a chemical substance that the user is attempting to ascertain;
with an integration module operatively connected to the spec engine module and the guide me module, in response to the required, optional, or excluded properties and the questions provided by the user, providing a group of recommended chemical substances;
with a ranking module, ranking the group of recommended chemical substances in a preferred order from first to last; and
with a ranking module, displaying, to the user, the ranked group of recommended chemical substances in the preferred order from first to last.

20. An method as defined in claim 19, additionally comprising:
with a similar properties module, providing the user with a list of similar chemicals for any selected one of the recommended chemicals identified by the interactive system.
